(19) United States
(12) Patent Application Publication
(10) Pub. No.: US 2008/0065303 A1
(43) Pub. Date: Mar. 13, 2008

(54) Method For Automatically Actuating Interwheel Differential Locks In Vehicles, Particularly In Mobile Machinery And Emergency Vehicles

(75) Inventors: Hugo Burkhart, Ravensburg (DE); Bernd Aumann, Amtzell (DE); Udo Hiller, Meckenbeuren (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/632,787

(22) PCT Filed: Jun. 21, 2005
(86) PCT No.: PCT/EP05/06667

§ 371 Date: Jan. 18, 2007

(30) Foreign Application Priority Data
Jul. 30, 2004 (DE) 10 2004 037195.4

(51) Int. Cl. G06F 19/00

(52) U.S. Cl. 701/58

(57) ABSTRACT

A method for the activation of differential locks for vehicles, especially for such vehicles as may be used in construction work and field operations. The differential locks are always open, if the driving situation is such that a blocking operation is assuredly not required and, conversely in all other situations, the differential locks are closed.

This application is a national stage completion of PCT/EP2005/006667 filed Jun. 21, 2005, which claims priority from German Application Serial No. 10 2004 037 195.4 filed Jul. 30, 2004.

### FIELD OF THE INVENTION

The present invention concerns a method for the automatic activation of differential locks in vehicles, especially for such vehicles as may be used in construction work and/or open field operations.

### BACKGROUND OF THE INVENTION

Conventional mobile construction equipment, generally in an articulated formation with a power vehicle, for instance, dump trucks, outside excavators, front-loaders or other movable machines, are equipped with power-lift transmissions, which allow shifting under load and incorporate torque converters and/or hydraulically activated clutches. In the transmission output torque string of a respective construction vehicle is an additional, auxiliary center differential is frequently installed therein which, when its blocking capability is prohibited, permits an apportionment of torque between front and rear axles. With blocking of the auxiliary center differential removed, conversely such a vehicle would allow a direct through drive. Also, differential locks are to be found in the at least front and rear axles of such a vehicle.

The respective differentials for multi-wheel drive vehicles are regulated by differential clutches, also known as differential locks, whereby such differential locks, controlled by parameters derived from driving conditions, possess the ability to be connected or disconnected, i.e., to be activated or deactivated in their function.

The in-shifting of a load carrying, differential lock, which could be carried out by a hydraulically activated disk clutch, can be effected by slip control, i.e., by automatic compensation of the speed of rotation of the wheels.

DE 197 49 919 A1 discloses such a method. In this case, within the framework of slip control, the speeds of rotation of two output shafts of the differential are compared against one another. Then, from the results of such a comparison, slip signals are created where, as soon as a threshold value is overstepped, a connection of a locking clutch of the involved differential is activated, while giving consideration to the angle of the steering curve. An additional method, in accord with the last mentioned, determines the speed of rotation of the wheels and is the object of DE 197 48 086 A1.

EP 0 424 932 B1 teaches that for disconnecting of the differential lock, i.e., to release the locking clutch, the ratio of the respective torques present on the two transmission shafts, has to be accepted as a usable, first characteristic value. This continually determined, first-characteristic value is to be compared with a given torque ratio established as a transmission ratio. The latter is considered as an established set-characteristic value. Due to this comparison, an additional adjustment apparatus is employed for changing the amount of deviation in order to alter the torque loading of the input-or-output drive string. With the action of this adjustment apparatus, the requisite shifting conditions for the release of the locking clutch are fulfilled, so that after the attainment of this requisite shifting condition, the locking clutch is disconnected and thereby the differential lock opens.

EP 0 410 441 A2 discloses a differential lock for motor vehicles where, due to parameters of the driving operation, this differential lock can be connected or disconnected. For connection or disconnection of the differential lock, data representing the motor vehicle operation are input into a control apparatus, wherein these data concern predominately the speeds of rotation of at least two input shafts. In order to enable a disconnection of the differential lock, without being continually forced to release the locking clutch for the measurement of the speeds of rotation following a locking operation—as mentioned above—space is provided so that sensors can be placed on the shafts for a running determination of their speeds of rotation. Accordingly, from the measurements, the state of the values are stored in a control device, especially a value, which relates to the adjustment of the accelerator pedal and also the torque value, which can be attributed to the chosen transmission gear stage and finally the ratio of two torques for the disconnection of the differential lock. By way of a comparison of these stored values with actual values, connection and disconnection of the differential lock can be more closely brought into perfect fit with the existing driving conditions of the vehicle.

The measurement of speeds of rotation directly from the wheels is necessary because of the poor availability of these speeds of rotation where construction vehicles or movable field machines are concerned. Due to the exposed conditions and difficult construction tasks, given speeds of rotation in such cases would otherwise be unreliable.

The implementation of the method for automatic activation of differential locking, according to the state of the technology, shows itself in a disadvantageous manner, not only because of necessary sensor applications, but also because of being technically complex and highly cost intensive. This is true, especially in use with construction units or movable machines, since in the particular applications common thereto, special loadings occur, especially where sensors are concerned. Further, the use of self-acting differential locks react in a negative way with regard to fuel conservation and in preventing tire deterioration.

Thus the present invention has the purpose of making a method available for the automatic activation of differential locks in the case of motor vehicles, especially where construction units or movable machines are concerned where, for the carrying out of the purpose, necessary parameters are already at hand and where the driving condition of the vehicle, especially in critical experiences, would not be improperly influenced. Furthermore, the invented method is to require no additional sensor equipment.

### DETAILED DESCRIPTION OF THE INVENTION

Accordingly, the proposal is to base the connection and disconnection of the differential lock on the driving and load conditions of the vehicle, where the vehicle speed and the torque of the output drive shaft of the transmission would serve as parameters.

According to the invention, provision is made that the differential locks are to be connected when the vehicle speed falls below a predetermined threshold value of v_{—}1 and the transmission output torque exceeds a predetermined threshold value designated T_Ab1.

Provision is also made that currently operating differential locks in a selected shift position, upon exceeding another predetermined threshold, namely v_{—}2, and/or upon falling below an additional threshold T_Ab2 open for the passage of transmission output torque, where v_{—}2 is greater than v_{—}1 and T_Ab2 is less than T_Ab1.

With these given conditions, the basics of the inventive method are established to the end that these conditions are sufficient to establish a need of differential locks in their operating purpose and that the differential locks become engaged only in driving situations where the behavior of the vehicle would not be noticeably encroached upon. For example, if the transmission output torque is high and the vehicle speed is low, then the probability is that a vehicle wheel is spinning. If the transmission output torque is small or the speed of the vehicle is high, then the danger is somewhat remote that a wheel is spinning. By way of the invented opening of the locks at high speeds, dangerously critical driving situations are avoided.

By way of the inventive method, assurance is provided that the differential lock is to be found open whenever driving situations arise, where locking action is certainly not required and, conversely under all other conditions, the differential lock is closed. In this manner, the sensor technology required by the state of the technology becomes obsolete as it is not needed to detect a necessity for the locking.

That value which is required as a parameter of the transmission output drive torque can be determined in an advantageous manner by a presently operating gear stage and input torque of the transmission as these are reflected by the difference in speed of rotation of a hydrodynamic converter.

In order to be assured that differential locks do not activate themselves in driving situations, where the lack of differential effect would act negatively on the behavior of the driving mode, it is possible that the threshold value of the transmission torque T_Ab1 can be correspondingly adjusted to a higher level.

Within the framework of a particularly advantageous embodiment of the inventive method, a proposal is offered to the effect that the threshold value of a transmission output torque T_Ab1 can be adjusted by the driver by way of an appropriate apparatus, this apparatus. This apparatus is, for example, a rotary potentiometer installed in the instrument panel, the values of which can be manually set to vehicle conditions. In this way, the threshold value T_Ab1 can be made to fit the transmission output torque with consideration given to the operating surroundings, such as weather, working surface and the like. Moreover, the driver can so adjust the threshold upon a slippery roadway; that the differential locks would not close upon any small torques. In the case of a dry, well gripped roadway, it is possible by way of an appropriate adjustment of the differential lock that this can be closed only by a higher torque. Since these parameters, generally, within a typical application, seldom change themselves, such manual intervention is not necessarily or at least only seldom required.

According to the invention, provision is made that a change in the value of the threshold of the transmission output torque T_Ab1 also results in a change in the value of the transmission output torque threshold T_Ab2. This can be accomplished by way of an algorithm or characteristic curve related input into the control.

For example, in a case wherein the potentiometer is used for the adjustment of the threshold value T_Ab1, the following functionalities are realized relating to the potentiometer readings:
Final reading No. 1: Differential locks (inter-wheel differential lock) are never closed,
Final reading No. 2: Differential locks are manually closed, and
   In the intervening zone between No. 1 and No. 2: A stepless adjustment of the threshold T_Ab1 is possible.

By way of this formulation, further intervention by the driver is not necessary. This is due to the fact that a foot switch, normally found in a vehicle to enable the driver to close the locking system, can be eliminated. In an advantageous manner for the execution of the method, no additional sensors are needed since, instead of a separate sensor for speed of rotation, the already available sensor in the transmission output can be used. Further, by using proper control of the differential locks in an articulated front-end loader with a direct through drive between front and rear axles, it is possible that the steering angle regulation can be eliminated.

According to the invention, provision can also be made that the threshold value for the vehicle speed, namely v_{—}1, can be adjusted by the driver.

The inventive method is intended for vehicles designed for construction work and field operations. These are generally front end loaders; the working application of which take precedence over transport usage.

1-6. (canceled)

7. A method for automatically activating inter-wheel differential locks in a vehicle to one of maintain the inter-wheel differential locks in a locked arrangement, when a driving situation does not require a compensating function of the inter-wheel differential locks and unlocking the inter-wheel differential locks when locking the inter-wheel differential locks would negatively affect driving characteristics, the method comprising the steps of:
setting a third predetermined threshold value (v_{—}2) greater then a first predetermined threshold value (v_{—}1) and a fourth predetermined threshold value (T_Ab2) and less than a second predetermined threshold value (T_Ab1);
locking the inter-wheel differential locks when a vehicle velocity is less than the first predetermined threshold value (v_{—}1) and a transmission output torque is greater than the second predetermined threshold value (T_Ab1); and
unlocking the inter-wheel differential locks from a selected shifted position when one of the vehicle velocity is greater than the third predetermined threshold value (v_{—}2) and the transmission output torque is less than the fourth threshold value (T_Ab2).

8. The method for automatically activating the inter-wheel differential locks according to claim 7, further comprising the step of allowing a driver to adjust the second predetermined threshold value (T_Ab1).

9. The method for automatically activating the inter-wheel differential locks according to claim 8, further comprising the step of adjusting the fourth threshold value (T_Ab2) by one of an algorithm and a characteristic line value input into a control when the second predetermined threshold value (T_Ab1) is adjusted.

10. The method for automatically activating the inter-wheel differential locks according to claim 8, further comprising the step of employing a potentiometer for adjusting the second predetermined threshold value (T_Ab1) such that, at a first potentiometer reading the inter-wheel differential locks are never locked, at a second potentiometer reading the inter-wheel differential locks are manually locked, and at a reading between the first and the second potentiometer readings, stepless adjustment of the second predetermined threshold value (T_Ab1) is possible.
